(19) United States
(12) Patent Application Publication
(10) Pub. No.: US 2008/0229100 A1
(43) Pub. Date: Sep. 18, 2008

(54) SECURE DATA MANAGEMENT USING NON-VOLATILE MEMORY

(76) Inventors: Thomas Trodden, Albuquerque, NM (US); Jim S. Baca, Corrales, NM (US); Ronald Tafoya, Sandia Park, NM (US)

Correspondence Address: TROP, PRUNER & HU, P.C., 1616 S. VOSS RD., SITE 750, HOUSTON, TX, 77057-2631, US

(21) Appl. No.: 11/684,752

(22) Filed: Mar. 12, 2007

(51) Int. Cl. H04L 9/00

(52) U.S. Cl. 713/161

(57) ABSTRACT

In one embodiment, encrypted data is received from an authenticated remote host at a non-volatile memory. The encrypted data includes received user data, received data volatility information, and received data validity rules. The encrypted data is stored in the non-volatile memory, and a data volatility flag and data valid flag in the non-volatile memory device are set based on the received data volatility information and the received data validity rules. The data may be read from the non-volatile memory by a user if data access is permissible as determined by the data volatility flag and the data valid flag set by the remote host.

### BACKGROUND

Secure storage of downloaded digital content is a concern for content providers of digital media. Content providers using a pay-per-use or subscription download model must ensure that the data sent to a user is secure and cannot be copied or otherwise distributed without permission. Users who utilize these services must be able to download and store content securely, and also must be able to access the content per the terms of a usage or subscription agreement.

### BRIEF DESCRIPTION OF THE DRAWINGS

A better understanding of embodiments of the present invention can be obtained from the following detailed description in conjunction with the following drawings, in which:

FIG. 1 is a block diagram illustrating secure communication between a host and a user device according to some embodiments.

FIG. 2 is a flow diagram illustrating an authenticated data write to a non-volatile memory according to some embodiments.

FIG. 3 is a flow diagram illustrating a read operation according to some embodiments.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine (e.g., a computer). For example, a machine-readable medium may include a storage medium, such as but not limited to read only memory (ROM); random access memory (RAM); magnetic disk storage media; optical storage media; a flash memory device, etc. A machine-readable medium may also include a propagated signal which has been modulated to encode the instructions, such as but not limited to electromagnetic, optical, or acoustical carrier wave signals.

The term “wireless” and its derivatives may be used to describe circuits, devices, systems, methods, techniques, communications channels, etc., that communicate data by using modulated electromagnetic radiation through a non-solid medium. The term does not imply that the associated devices do not contain any wires, although in some embodiments they might not. The term “mobile wireless device” is used to describe a wireless device that may be in motion while it is communicating.

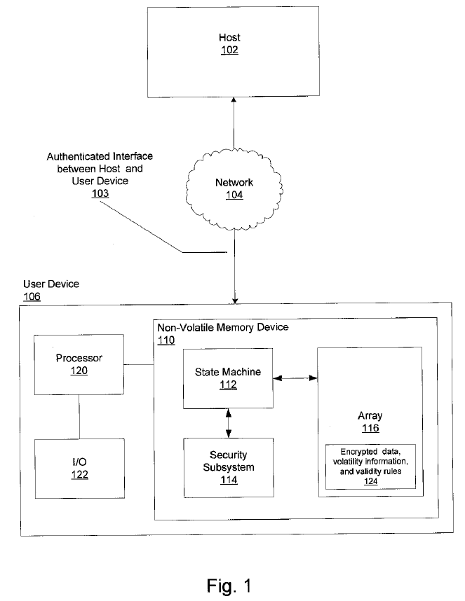

FIG. 1 is a block diagram illustrating secure communication between a host device (102) and a user device (106) over a network (104). The host device may be, for example, a content provider. The user device may be, for example, a wireless mobile computing device, mobile telephone, handheld computing device, set top box, or another type of computing device. Secure communications between the host (102) and the user device (106) may occur over an authenticated interface (103) between the host and the user device. In some embodiments, authentication between the host and the user device may be performed using a Public Key Infrastructure (PKI).

The user device (106) may include a processor (120), a non-volatile memory device (110) coupled to the processor, and one or more input/output (I/O) devices (122) coupled to the processor. The non-volatile memory device may be a NAND-type or NOR-type flash memory device, or may be another type of non-volatile memory. In some embodiments, the non-volatile memory device (110) may be a flash memory device that is embedded as part of a chipset, part of a microprocessor or microcontroller, or embedded in another component in the user device. For example, the processor (120) may include a flash memory device as part of same silicon die or in the same package in some embodiments.

The non-volatile memory device (110) may be a secure flash device that includes a security subsystem (114), a state machine (112) coupled to the security subsystem, and an array of memory cells (116) coupled to the state machine. The security subsystem (114) may include an embedded authentication and encryption engine capable of performing PKI authentication. Thus, the non-volatile memory device can provide authentication of the host device (102) or other devices or users over a network (104)

The array of memory cells (116) may include one or more secure regions (124). These secure regions can be used to store encrypted data and associated encrypted data volatility information and/or encrypted data validity rules sent by the host (102) over an authenticated interface (103). For example, after being authenticated to the user device, the host (102) may send encrypted data to the user device (106) via the network (104). The encrypted data may be, for example, a multimedia file, or a data file, such as a data file including a user's medical prescription information or other data. It should be noted that the encrypted data may be any type of data sent by a host who wishes to retain control of the data usage and data expiration, and is not limited to multimedia files or medial prescription information.

Accompanying the encrypted data may be data volatility information sent from the host (104) indicating the conditions under which the encrypted data may be accessed by a user of the user device (106). Also accompanying the encrypted data may be data validity rules sent from the host (104) indicating one or more actions to be performed upon expiration of the data. For example, the data volatility information may include an expiration date and/or time, a number of allowed accesses, or a number of software licenses or copies allowed. The data validity rules may indicate that upon expiration of the data, the data is to be erased or the user is to be prompted to renew a license or subscription. In some cases, the data volatility information may indicate that the data is always valid, and does not expire.

The encrypted data and the data volatility information and rules related to the encrypted data may be stored in the memory array (124). A user of the device (106) may only access the encrypted file based on the data volatility information and rules sent by the host (102) and stored in the non-volatile memory device (110). Each time a user of the user device (106) attempts to access the encrypted data from the array, the state machine may determine whether access to the data is allowed based on the data volatility information associated with the encrypted data and/or data validity rules associated with the encrypted data.

The encrypted data and associated data volatility information and data validity rules stored in the non-volatile memory device (110) may not be modified except by the authenticated host device (102). The host may update the encrypted data, data volatility information, and/or data validity rules at any time, so long as the host is authenticated to the user device. In this manner, the host retains control over the encrypted data even though the data physically resides at the user device (104) and not at the host device (102).

Thus, secure, encrypted data may be sent from the host (102) to the user device (106) over an authenticated interface (103). The host (102) may also send encrypted data volatility information and/or encrypted data validity rules associated with the data to the user device (106) over the authenticated interface (103). The encrypted data and associated volatility information and rules may be stored in the non-volatile memory device (110, 124). The state machine (112) controls access to the secure data based on the data volatility information and/or a data validity rules provided by the host. Thus, data security and authentication on the user device (106) is both operating system and file system agnostic, and is managed by the state machine (112) and security subsystem (114) based on data volatility information and/or data validity rules provided by the host (102).

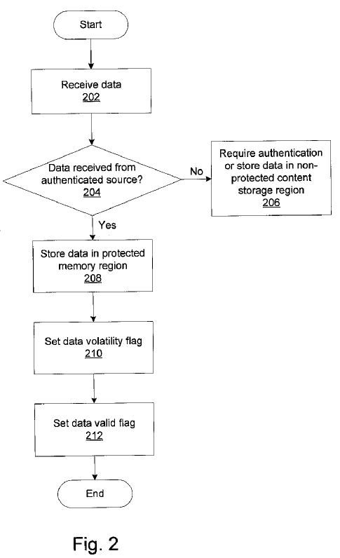

FIG. 2 is a flow diagram illustrating an authenticated data write to a non-volatile memory device according to some embodiments. An authenticated data write may begin when data is received at the non-volatile memory device (202) from a host source. The received data may be encrypted, and may include user data, such as multimedia content or other user information, as well as content protection data, such as data volatility information and/or data validity rules, as described above.

A security subsystem within the memory device may determine if the received data is from an authenticated source (204), such as, for example, a source authenticated using PKI authentication. If the data is not from an authenticated source, authentication of the source may be required before the data is written to the non-volatile memory device (206). Alternatively, if the data is not received from an authenticated source, it may not be treated as secure data, and may be stored in an unprotected region within the memory device (206) with no associated content protection data.

If the data is received from an authenticated source (204), it may be stored in a protected region within the memory device (208). A data volatility flag may be set (210) based on the content protection information received from the host. The data volatility flag may indicate, for example, a date when the data is to expire, or a number of accesses to the data permitted before the data expires. The data volatility flag may be encrypted and stored in the protected memory region with the user data, and may not be modified unless the host initiates an authenticated session with the non-volatile memory device to modify the data volatility flag.

A data validity flag may also be set (212) based on the content protection information received from the host. The data validity flag may be used by the state machine in conjunction with the data volatility flag to determine when, if ever, the protected data is to be erased from the memory device, or if another action, such as a user prompt for action, is to be performed. The data validity flag may be encrypted and stored in the protected memory region with the user data, and may not be modified unless the host initiates an authenticated session with the non-volatile memory device to modify the data validity flag.

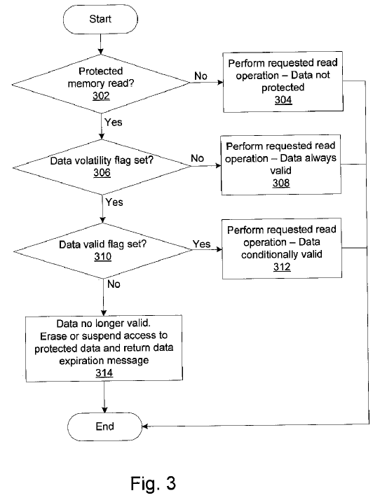

FIG. 3 is a flow diagram illustrating a read operation according to some embodiments. When a user initiates a read operation from a non-volatile memory device in a user device, a determination may be made whether the read is to a protected region in memory (302). A protected region in memory may be defined as a contiguous or non-contiguous range of logical or physical addresses in memory that store encrypted data, encrypted data volatility information associated with the encrypted data, and/or encrypted data validity rules associated with the encrypted data sent to the user device by an authenticated host device. If the read operation is not a read of a protected region, the requested read operation may be performed (304). In this case, the data is not protected.

If the read operation is a read of a protected region, a determination of whether a data volatility flag is set is made (306). As described above, the data volatility flag may indicate one or more conditions upon which the data stored in the protected region may no longer be accessible to a user. For example, the data volatility flag may indicate that data is to expire after a particular time period or after a number of accesses. In some embodiments, the data volatility flag may be set and/or modified based only on data volatility information sent by an authenticated host device. If the data volatility flag is not set the requested read operation of the protected data may be performed (308). In this case, the protected data will always be valid because no data volatility flag is set.

If a data volatility flag is set, this indicates that the host device intends the protected data be accessible only if certain conditions are met. In this case, a determination may be made whether a data valid flag is set (310). The data valid flag may be set and/or modified by the state machine based on data volatility information and/or data validity rules sent by an authenticated host device. For example, if the data volatility flag indicates that protected data is to expire at a particular date and time, the state machine may set the data valid flag to invalid at the date and time indicated. In another embodiment, if the data volatility flag indicates that protected data is to expire after a predetermined number of accesses, the state machine may track the number of accesses to the protected data and set the data valid flag to invalid when the maximum number of accesses has occurred. In yet another embodiment the data valid flag may include rules indicating that the data would be valid if the user performs a particular action, such as renewing a subscription. In this case, the user may be prompted to perform an action, and access to the data may be suspended until the conditions of access are satisfied.

If the data valid flag is set, indicating that the data is still valid and access by a user is allowed, the requested data read operation will be performed (312). In this case, the protected data is conditionally valid, and may later become invalid based on the data volatility information and data validity rules set by the host and associated with the protected data.

If the data valid flag is not set (314), this is an indication that access to the requested protected data is no longer permitted based on the data volatility information and data validity rules set by the host and associated with the protected data. In some embodiments, when the data valid flag is no longer set, the associated protected data may be permanently erased from the non-volatile memory array. In other embodiments, the protected data may remain in the non-volatile memory array, but may be inaccessible to a user until certain conditions of the protected data provider are met. For example, a protected multimedia file that has expired due to elapsed time may become accessible again after the user pays a subscription or renewal fee. The payment of the fee may trigger the host content provider to authenticate with the user device and update the data volatility and/ or data validity rules for the protected multimedia file. Similarly, a protected data file containing medical prescription information that has expired, and thus is inaccessible due to the prescription lapsing, may become accessible again after a doctor approves an extension for the prescription. Thus, the host content provider retains control over the protected content stored on the user device as well as the data volatility and validity characteristics of the protected content.

Thus, a method, system, and apparatus for secure data management using non-volatile memory are disclosed. In the above description, numerous specific details are set forth. However, it is understood that embodiments may be practiced without these specific details. In other instances, well-known circuits, structures, and techniques have not been shown in detail in order not to obscure the understanding of this description. Embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

We claim:

1. A method comprising:
receiving encrypted data from an authenticated remote host at a non-volatile memory, wherein the encrypted data includes received user data, received data volatility information, and received data validity rules;
storing the encrypted data in the non-volatile memory;
setting a data volatility flag in the non-volatile memory based on the received data volatility information; and
setting a data valid flag in the non-volatile memory based on the received data validity rules.

2. The method of claim 1, wherein the data volatility flag indicates a time period after which the user data is no longer valid.

3. The method of claim 1, wherein the data volatility flag indicates a number of times the user data may be accessed before the user data is invalidated.

4. The method of claim 1, wherein the data volatility flag indicates a number of licenses available before the user data is invalidated.

5. The method of claim 1, further comprising requesting a read of the encrypted data from the protection region of the non-volatile memory, determining if the data volatility flag is set, and if the data volatility flag is set, determining if the data valid flag is set.

6. The method of claim 5, further comprising if the data valid flag is set, performing a read operation of the encrypted data.

7. The method of claim 5, further comprising if the data valid flag is not set, erasing the encrypted data and returning a data expiration message.

8. The method of claim 5, further receiving updated data volatility information and updated data validity information from the authenticated remote host, resetting the data volatility flag in the non-volatile memory based on the updated data volatility information, and resetting the data valid flag in the non-volatile memory based on the updated data validity rules.

9. A non-volatile memory comprising:
a state machine;
a security subsystem coupled to the state machine; and
an array of memory cells coupled to the state machine, wherein the state machine is to manage expiration of protected data stored in the array based on at least a data volatility flag associated with the protected data and stored in the array and a data valid flag associated with the protected data and stored in the array, wherein the the data volatility flag, and the data valid flag are set by an authenticated remote host.

10. The non-volatile memory of claim 9, wherein the security subsystem is to perform encryption and decryption operations on the protected data.

11. The non-volatile memory of claim 9, wherein the data volatility flag and the protected data are received from an external host over a network.

12. The non-volatile memory of claim 11, wherein the state machine is to update the data valid flag if a time period indicated by the data volatility flag has passed.

13. The non-volatile memory of claim 11, wherein the state machine is to update the data valid flag if a number of user accesses indicated by the data volatility flag has been exceeded.

14. The non-volatile memory of claim 11, wherein the state machine is to update the data valid flag if a number licenses indicated by the data volatility flag has been exceeded.
